(19) United States
(12) Patent Application Publication
(10) Pub. No.: US 2019/0267727 A1
(43) Pub. Date: Aug. 29, 2019

(54) CONNECTOR ARRANGEMENT

(71) Applicant: Rosenberger Hochfrequenztechnik GmbH & Co. KG, Fridolfing (DE)

(72) Inventors: Martin ZEBHAUSER, Laufen (DE); Thomas LÖDDING, Traunstein (DE); Johannes SCHMID, Altotting (DE)

(21) Appl. No.: 16/283,915

(22) Filed: Feb. 25, 2019

(30) Foreign Application Priority Data
Feb. 26, 2018 (DE) 10 2018 104 253.1

(51) Int. Cl. H01R 9/05; H01R 13/6592; H01R 4/18; H01R 13/6473; H01B 11/18; H01B 11/00; H01B 7/08

(52) U.S. Cl. CPC H01R 9/05; H01R 13/6592; H01R 4/183; H01B 7/0807; H01B 11/1869; H01B 11/002; H01R 13/6473

(57) ABSTRACT

The present invention relates to a connector arrangement (10) having a connector (12) and a cable (14) connected to the connector, which each have at least one conductor pair (16) having a first and second conductor for transmitting a differential signal, wherein the cable has a first portion (18) and the connector has a second portion (20) in which the conductor pair has electric contacts, wherein the cable is fastened to the connector at a connector-side end of the first portion and the conductors of the conductor pair of the cable are fastened to the conductors of the connector at a cable-side end of the second portion, wherein an intermediate portion (22) is formed between the first portion and the second portion, wherein the conductor pair is surrounded in the intermediate portion and, in particular, in the first portion and/or in the second portion by an outer conductor (24), and wherein the outer conductor has a deformation (26) in at least one part of the intermediate portion, said deformation reducing a distance (V) between the outer conductor and the conductors and/or a distance (W) between the conductors in a region of the deformation. The invention further relates to a production method for a connector arrangement.

### FIELD OF THE INVENTION

The invention relates to a connector arrangement having a connector and a cable connected to the connector. The cable guides at least one conductor pair for transmitting a respective differential signal.

### TECHNICAL BACKGROUND

DE 202015000753 U1 discloses a connector arrangement comprising a sleeve part. In that case, a core pair for transmitting a differential signal runs in a cable, wherein the cores of the core pair are at a first mutual distance in the interior of the cable. Proceeding from the sheathed cable portion in the direction of the connector, the two cores of the core pair diverge in an intermediate portion until they enter a guide portion of the connector, in which they are at a second mutual distance, which is greater than the first mutual distance.

On account of the change in distance between the cores, the differential impedance thereof changes, which can result in an interference point.

This is a state in need of improvement.

### SUMMARY OF THE INVENTION

In light of this background, the present disclosure teaches a connector arrangement for transmitting differential signals with an improved transmission characteristic.

Inter alia, the present disclosure teaches a connector arrangement having a connector and a cable connected to the connector, which each have at least one conductor pair having a first and second conductor for transmitting a differential signal, wherein the cable has a first portion and the connector has a second portion in which the conductor pair has electric contacts, wherein the cable is fastened to the connector at a connector-side end of the first portion and the conductors of the conductor pair of the cable are fastened to the conductors of the connector at a cable-side end of the second portion, wherein an intermediate portion is formed between the first portion and the second portion, wherein the conductor pair is surrounded in the intermediate portion and, in particular, in the first portion and/or in the second portion by an outer conductor, and wherein the outer conductor has a deformation in at least one part of the intermediate portion, said deformation reducing a distance (V) between the outer conductor and the conductors and/or a distance (W) between the conductors in a region of the deformation.

The present disclosure moreover teaches a production method for a connector arrangement having the following steps: providing a connector arrangement having a connector and a cable connected to the connector, which each have at least one conductor pair for transmitting a differential signal, wherein the cable has a first portion and the connector has a second portion in which the conductor pair has electric contacts, wherein the cable is fastened to the connector at a connector-side end of the first portion and the conductors of the conductor pair of the cable are fastened to the conductors of the connector at a cable-side end of the second portion, wherein an intermediate portion is formed between the first portion and the second portion, wherein the conductor pair is surrounded in the intermediate portion and, in particular, in the first portion and/or in the second portion by an outer conductor; deforming the outer conductor in at least one part of the intermediate portion.

The underlying concept of the present invention is to improve a connector arrangement with respect to different properties by deforming the outer conductor. For example, electrical properties such as the impedance or the EMC compatibility can be advantageously influenced by a deformation. Furthermore, the installation space can also be reduced or changed and the holding forces of a conductor pair in the connector arrangement can be improved.

Advantageous configurations and embodiments are disclosed in the description with reference to the figures of the drawing.

In some embodiments, the deformation is configured to set the impedance of the connector arrangement. The impedance can be set by virtue of the distance between the outer conductor and the conductors of the conductor pair or the distance between the conductors of the conductor pair being changed.

Accordingly, provision can be made for an interference point of the impedance in the intermediate portion in the connector arrangement to be prevented. In this case, an impedance in the intermediate portion corresponds to the reference impedance of the connector. The reference impedance is often 100 ohms.

As an alternative, it is expedient for the deformation to compensate for a high impedance before and/or after the deformation by a low impedance in the region of the deformation. A high impedance is greater than the reference impedance. A low impedance is smaller than the reference impedance.

The impedance is given as a complex-valued function of the frequency. Said impedance contains the ratio of the amplitudes of the sinusoidal AC voltage to the sinusoidal alternating current and also the shift of the phase angle between said two variables.

Accordingly, provision can be made for the deformation to initially overcompensate for an impedance value of the connector arrangement, as a result of which the high impedance before and/or after the deformation and the low impedance in the region of the deformation at least partly cancel each other out.

In some embodiments, the deformation is formed by magnetic forming, compression, puckering and/or folding. Compression, in particular, is a particularly simple type of deformation that can be used.

In some embodiments, the deformation is formed in such a way that the distance between the outer conductor and the conductors of the conductor pair in a region of the deformation disappears. In this case, one speaks of excessive pressing of the outer conductor by the deformation, if the deformation has been formed by compression.

Therefore, the holding forces of a connector can also be increased, for example.

In this respect, it is expedient when a smallest internal diameter of the outer conductor in the region of the deformation is smaller than or equal to a diameter of a conductor in a non-deformed region, when the deformation is formed on a top or bottom side of the outer conductor.

As an alternative or in addition, it may be expedient when a largest internal diameter of the outer conductor in the region of the deformation is smaller than two-times a conductor in a non-deformed region, when the deformation is formed on a side face of the outer conductor.

Accordingly, there is also excessive pressing of the outer conductor. In this way, a high impedance, with respect to the reference impedance, outside of the deformation can be overcompensated for by a low impedance, with respect to the reference impedance, in the region of the deformation.

In some embodiments, the outer conductor has a longitudinal gap in a region outside of the deformation. The longitudinal gap is produced through winding around the connector arrangement with an outer conductor when the opposite longitudinal edges of the outer conductor are not connected to one another.

In this way, the production costs of a connector can be reduced.

In this case, it is particularly advantageous when the longitudinal gap is made smaller or completely closed by the deformation so that the outer conductor no longer has a longitudinal gap. This is made possible by virtue of the outer conductor having a smaller circumference after the deformation than before the deformation. Therefore, the electrical properties, in particular EMC properties, of a connector arrangement can be improved.

In some embodiments, the connector arrangement has a crimp in a region outside of the deformation. Accordingly, the deformation of the connector arrangement, as has been described above, is not likely provided as connection technology between conductors of a cable and electric contacts. Accordingly, it is advantageous to provide a separate connection means between electrical conductors of a cable and electric contacts.

In some embodiments, the deformation is formed on a top side, on an opposite bottom side and/or on a side face between the top side and the bottom side of the outer conductor.

A top side, a bottom side and side faces are defined in this patent application in the drawings and the associated description.

In some embodiments, the deformation is formed as a corrugation. Corrugations can be produced in a particularly simple manner by means of a range of tools, for example by virtue of the region of the deformation being impacted by means of a pointed object.

As an alternative or in addition thereto, the deformation may also be a planar deformation. Planar deformations can be formed, for example, by means of pliers with suitable jaws or by means of magnetic forming.

It goes without saying that the features mentioned above and those to be explained below can be used not only in the respectively specified combination but also in other combinations or alone, without departing from the scope of protection of the present invention.

The above configurations and embodiments can be combined with one another as desired, provided this makes sense. Further possible configurations, embodiments and implementations of the invention also comprise not explicitly mentioned combinations of features of the invention described above or in the following text with respect to the exemplary embodiments. In particular, a person skilled in the art will also add individual aspects here as improvements or additions to the basic form of the present invention.

### BRIEF DESCRIPTION OF THE DRAWING

The present invention is explained in more detail below with reference to the exemplary embodiments specified in the schematic figures of the drawing. In this case:

FIG. 1A shows a longitudinal sectional illustration of one embodiment of the invention;

FIG. 1B shows a longitudinal sectional illustration of one embodiment of the invention;

FIG. 1C shows a longitudinal sectional illustration of one embodiment of the invention;

FIG. 1D shows a longitudinal sectional illustration of one embodiment of the invention;

FIG. 2 shows a longitudinal sectional illustration of a further embodiment of the invention;

FIG. 3A shows a cross-sectional illustration of one embodiment of the invention;

FIG. 3B shows a cross-sectional illustration of one embodiment of the invention;

FIG. 3C shows a cross-sectional illustration of one embodiment of the invention;

FIG. 3D shows a cross-sectional illustration of one embodiment of the invention;

FIG. 3E shows a cross-sectional illustration of one embodiment of the invention;

FIG. 3F shows a cross-sectional illustration of one embodiment of the invention;

FIG. 3G shows a cross-sectional illustration of one embodiment of the invention;

FIG. 3H shows a cross-sectional illustration of one embodiment of the invention;

FIG. 3I shows a cross-sectional illustration of one embodiment of the invention;

FIG. 3J shows a cross-sectional illustration of one embodiment of the invention;

FIG. 4A shows a cross-sectional illustration of one embodiment of the invention;

FIG. 4B shows a cross-sectional illustration of one embodiment of the invention;

FIG. 4C shows a cross-sectional illustration of one embodiment of the invention;

FIG. 5 shows a longitudinal sectional illustration of one embodiment of the invention.

The appended figures of the drawing are intended to impart a further understanding of the embodiments of the invention. Said figures illustrate embodiments and serve to explain principles and concepts of the invention in connection with the description. Other embodiments and many of the mentioned advantages result with respect to the drawings. The elements of the drawings are not necessarily shown in a manner true to scale with respect to one another.

In the figures of the drawing, identical, functionally identical and identically acting elements, features and components—unless otherwise stated—are each provided with the same reference signs.

In the following text, the figures are described coherently and comprehensively.

### DESCRIPTION OF EXEMPLARY EMBODIMENTS

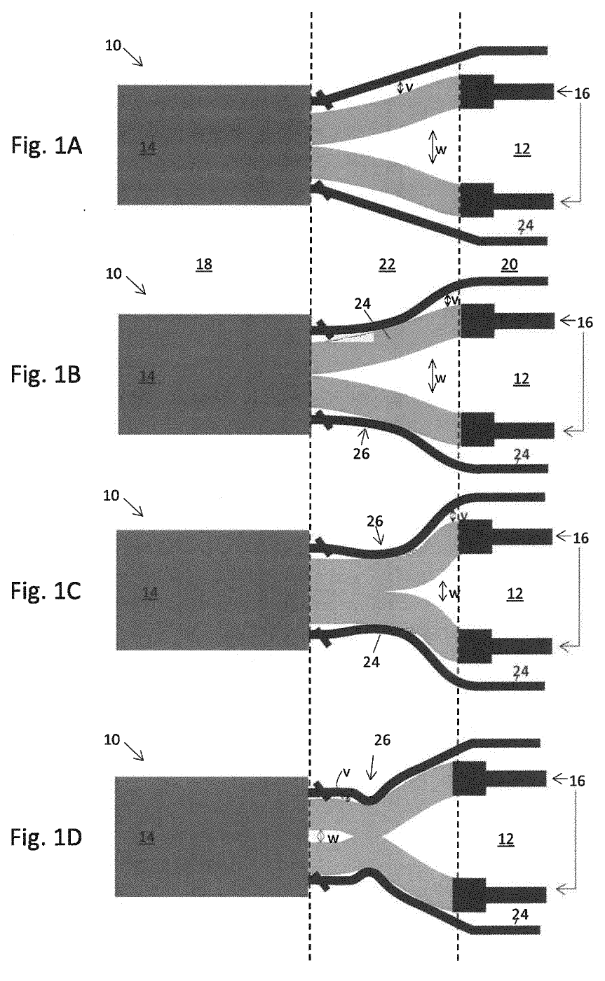

FIGS. 1A, 1B, 1C and 1D each show a schematic sectional view of a connector arrangement 10. The connector arrangement 10 comprises a connector 12 and a cable 14 connected to the connector 12. Both the cable 14 and the connector 12 each have at least one conductor pair 16 for transmitting a differential signal. The conductor pair 16 can be formed in the connector as an electric contact pair. In the cable, the conductor pair can be formed as a core pair.

The connector arrangement 10 has a first portion 18 in the cable. Furthermore, the connector arrangement 10 has a second portion 20 on the connector side. An intermediate portion 22 is formed between the first portion 18 and the second portion 20. In said intermediate portion 22, the distance between the conductors of the conductor pair 16 increases from the smaller distance between the cores in the first portion 18 to the larger distance between the electric contacts in the second portion 20.

The connector arrangement 10 has an outer conductor 24 both in the first portion 18 and in the second portion 20 and in the intermediate portion 22.

The distance between the conductors of the conductor pair 16 in the intermediate portion 22 is denoted by W. The distance between the outer conductor 24 and the conductors of the conductor pair 16 in the intermediate section 22 is denoted by V.

FIG. 1A shows a connector 10 before the outer conductor 24 has been deformed in the region of the intermediate portion 22.

FIG. 1B shows a connector arrangement 10 with a deformed outer conductor 24. The connector arrangement 10 according to FIG. 1B accordingly has a deformation 26 in the intermediate portion 22, said deformation reducing the distance between the conductors of the conductor pair 16 and the outer conductor 24. The deformation 26 is formed as a planar deformation.

The connector arrangement 10 according to FIG. 1C has a deformation 26 of the outer conductor 24 in the intermediate portion 22. The deformation 26 is formed in FIG. 1C as a relatively flat corrugation and reduces the distance between the outer conductor 24 and the conductor pair 16. Furthermore, the deformation 26 in FIG. 1C also reduces the distance between the conductors of the conductor pair 16 with respect to one another.

The connector arrangement according to FIG. 1D has a deformation 26 of the outer conductor 24 in the intermediate portion 22. The deformation 26 is formed as a corrugation. Said corrugation in FIG. 1D is excessively pressed by virtue of the corrugation being shaped in such a way that the outer conductor 24 and the conductors of the conductor pair 16 partly overlap.

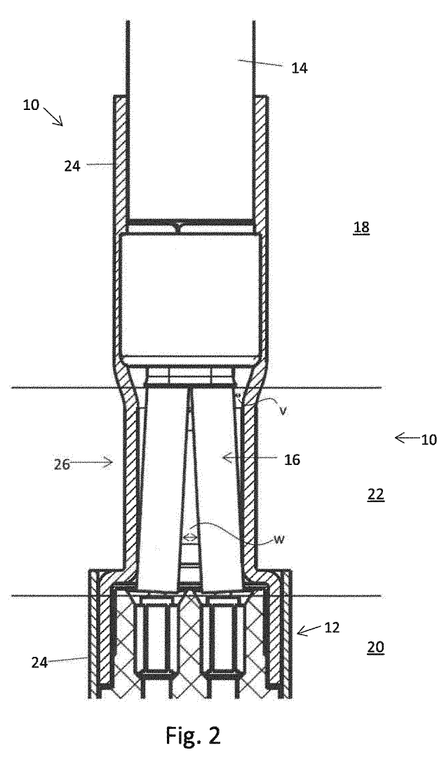

FIG. 2 shows a schematic sectional view of a connector arrangement 10 according to one embodiment of the invention. FIG. 2 shows a further deformation 26, which is of planar design.

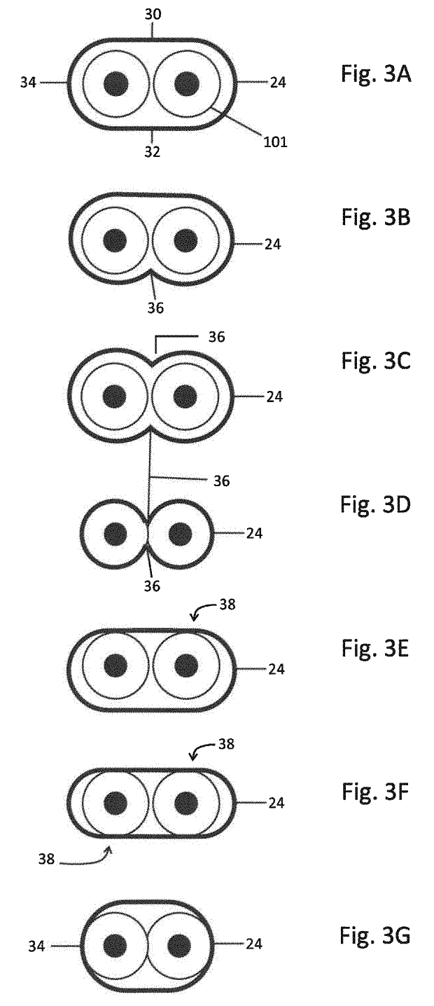

FIGS. 3A to 3J each show a cross-sectional view of a connector arrangement 10. FIG. 3A shows a cross-sectional view of a connector arrangement 10 in a region outside of the deformation. Accordingly, FIG. 3A does not show a deformation of the outer conductor 24. The outer conductor 24 has a top side 30, an opposite bottom side 32 and two side faces 34, which are each formed between the top side 30 and the bottom side 32. In the case of connector arrangements having different side lengths, in this patent application, the long sides in each case form the bottom side 32 and the top side 30, respectively. The short sides 34 form the side faces.

FIGS. 3B to 3J each show a cross-sectional view of a connector arrangement 10 in a region of a deformation 26.

In FIG. 3B, the deformation 26 is formed as a corrugation 36 on a bottom side 32 of the outer conductor 24. In FIG. 3B, the corrugation 36 reduces the distance V between the outer conductor 24 and the conductors of the conductor pair 16.

FIG. 3C illustrates a deformation on the top side 30 and on the bottom side 32 of the connector arrangement 10. The deformations on the top side 30 and on the bottom side 32 are each formed as corrugations 36 and reduce in this region the distance V between the conductors of the conductor pair 16 and the outer conductor 24.

In FIG. 3D, the outer conductor 24 is deformed in such a way that it substantially follows the contour of the insulating part 101. Accordingly, the distance between the outer conductor 24 and the conductors of the conduct pair 16 is reduced. Such a deformation can be produced, for example, by means of magnetic forming. Accordingly, the deformation from FIG. 3D changes the distance V between the outer conductor 24 and the conductors of the conductor pair 16 and the distance W between the conductors of the conductor pair 16 with respect to one another.

FIG. 3E shows a planar deformation 38 of the outer conductor 24 on the top side 30 thereof.

FIG. 3F shows an outer conductor having in each case a planar deformation 38 on the top side 30 of the outer conductor 24 and on the underside 32 thereof.

FIG. 3G shows a deformation of the outer conductor 24 on the side faces 34 thereof. Accordingly, the deformation 34 changes the distance W between the conductors of the conductor pair 16 and the distance V between the outer conductor 24 and the conductors of the conductor pair 16.

FIGS. 3A to 3G each show an oval outer conductor. However, it goes without saying that the possibilities for deforming an outer conductor 24 according to FIGS. 3B to 3G also relate to other outer conductor shapes.

By way of example, other outer conductor shapes are illustrated in FIGS. 3H-3J. FIGS. 3H-3J each show a cross-sectional view A of a connector arrangement 10 in a non-deformed region and a cross-sectional view B of a connector arrangement 10 in a deformed region.

FIG. 3H shows in the cross-sectional view A a round outer conductor 24 in a non-deformed region. In the cross-sectional view B of FIG. 3H, the connector arrangement 10 is illustrated in a deformed region. The deformation is formed as a lateral deformation and reduces the distance W between the conductors of the conductor pair 16 with respect to one another and the distance V between the conductors of the conductor pair 16 and the outer conductor 24.

The cross-sectional view A of FIG. 3I shows a connector arrangement 10 with a round outer conductor 24. In the cross-sectional view B of FIG. 3I, the outer conductor 24 is deformed to form an oval shape. Accordingly, the deformation 26 of FIG. 3I changes the distance V between the outer conductor 24 and the conductors of the conductor pair 16.

FIG. 3J shows in the cross-sectional view A a connector arrangement 10 with a square outer conductor 24. The cross-sectional view B of FIG. 3J has in each case a deformation 38 on the top side 30 and on the bottom side 38 of the outer conductor 24.

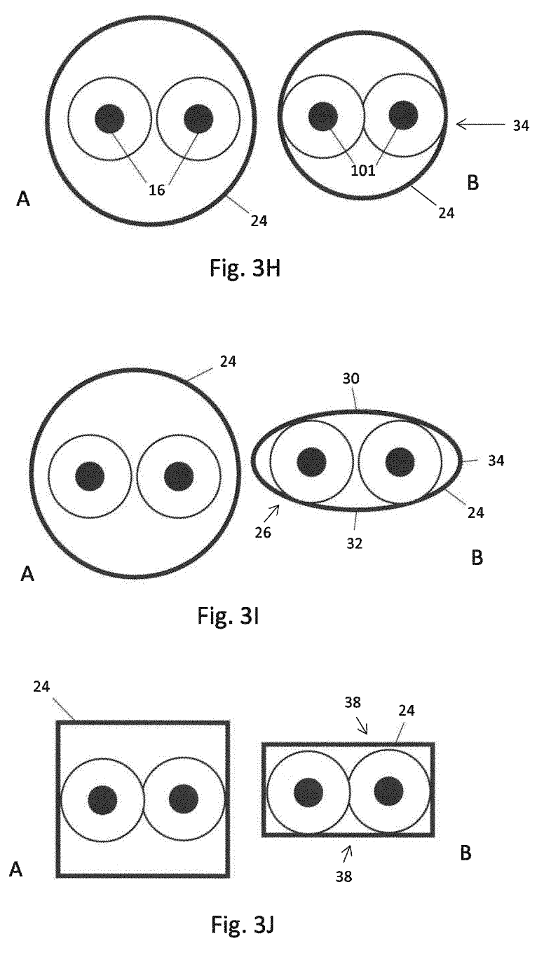

FIG. 4A shows a cross-sectional view of a connector arrangement 10 in a non-deformed region or before the deformation. The connector arrangement 10 in FIG. 4A has an outer conductor 24, which is wound around the insulating part 101 of the connector arrangement 10. Accordingly, the outer conductor 24 in FIG. 4A has two opposite longitudinal edges 103 and 104. A longitudinal gap 28 is located between the opposite longitudinal edges 103 and 104.

FIGS. 4B and 4C show a cross-sectional view of a connector arrangement 10 in a region of the deformation after the longitudinal gap 28 according to FIG. 4A has been closed by a deformation 26.

In FIGS. 4B and 4C, the longitudinal gap 28 has been closed in each case by virtue of the distance V between the conductors of the conductor pair 16 and the outer conductor 24 having been reduced in each case.

In FIG. 4B, the deformation is formed as a planar deformation 38.

In FIG. 4C, the deformation is formed as a corrugation 36.

In both FIGS. 4B and 4C, the outer conductor 24 has been deformed to such an extent until the opposite edges 103 and 104 thereof in each case overlap or contact one another. Provision may be made for the opposite edges 103 and 104 to be fastened to one another using a connecting technique, for example by means of a joining technique, in particular welding.

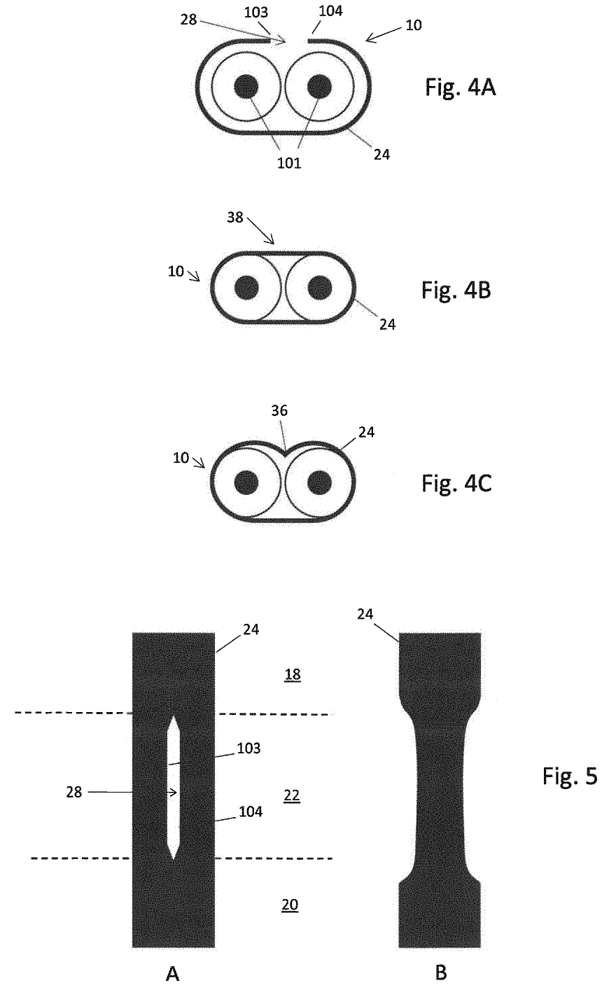

FIG. 5 shows the view A of a further schematic illustration of the outer conductor 24 of a connector arrangement before deformation and the view B after a longitudinal gap 28 has been closed by means of a deformation.

It can be seen in view A of FIG. 5 that a longitudinal gap 28 is formed in the intermediate portion 22 between opposite longitudinal edges 103 and 104 of the outer conductor 24. The longitudinal gap 28 extends exclusively over the intermediate portion 22.

View B of FIG. 5 shows the outer conductor 24, wherein the outer conductor 24 is deformed in the intermediate portion 22 in such a way that the gap 28 between the opposite longitudinal edges 103 and 104 of the outer conductor 24 overlaps.

The invention is not restricted to the embodiments subvariants illustrated. The invention concomitantly covers, in particular, all combinations of the features respectively claimed in the individual patent claims, the features respectively disclosed in the description and the features respectively illustrated in the figures of the drawing, insofar as they are technically practical.

Although the present invention has been fully described above on the basis of preferred exemplary embodiments, it is not restricted thereto, but rather modifiable in diverse ways.

The present disclosure may be summarized as disclosing, inter alia, the following Embodiments.

### Embodiment 1

Connector arrangement (10) having a connector (12) and a cable (14) connected to the connector, which each have at least one conductor pair (16) having a first and second conductor for transmitting a differential signal,
wherein the cable has a first portion (18) and the connector has a second portion (20) in which the conductor pair has electric contacts,
wherein the cable is fastened to the connector at a connector-side end of the first portion and the conductors of the conductor pair of the cable are fastened to the conductors of the connector at a cable-side end of the second portion,
wherein an intermediate portion (22) is formed between the first portion and the second portion,
wherein the conductor pair is surrounded in the intermediate portion and, in particular, in the first portion and/or in the second portion by an external conductor (24), and
wherein the outer conductor has a deformation (26) in at least one part of the intermediate portion, said deformation reducing a distance (V) between the outer conductor and the conductors and/or a distance (W) between the conductors in a region of the deformation.

### Embodiment 2

Connector arrangement according to Embodiment 1, wherein the deformation is configured to set the impedance of the connector arrangement.

### Embodiment 3

Connector arrangement according to Embodiment 2, wherein the deformation compensates for a high impedance, with respect to the reference impedance, before and/or after the deformation by a low impedance, with respect to the reference impedance, in the region of the deformation.

### Embodiment 4

Connector arrangement according to any one of Embodiments 1-3, wherein the deformation is formed by magnetic forming, compression, puckering and/or folding.

### Embodiment 5

Connector arrangement according to any one of Embodiments 1-4, wherein the distance between the outer conductor and the conductors in a region of the deformation is zero.

### Embodiment 6

Connector arrangement according to any one of Embodiments 1-5, wherein the distance between the conductors in a region of the deformation is zero.

### Embodiment 7

Connector arrangement according to Embodiment 5 or 6, wherein a smallest diameter of the outer conductor in the region of the deformation is smaller than a diameter of a conductor in a non-deformed region and/or wherein a largest diameter of the outer conductor in the region of the deformation is smaller than two-times a conductor in a non-deformed region.

### Embodiment 8

Connector arrangement according to any one of Embodiments 1-7, wherein the outer conductor has a longitudinal gap (28) in a region outside of the deformation.

### Embodiment 9

Connector arrangement according to any one of Embodiments 1-8, wherein a longitudinal gap in the region of the deformation is made smaller or closed.

### Embodiment 10

Connector arrangement according to any one of Embodiments 1-9, which has a crimp in a region outside of the deformation.

### Embodiment 11

Connector arrangement according to any one of Embodiments 1-10, wherein the deformation is formed on a top side (30) and/or on an opposite bottom side (32) and/or on a side face (34) between the top and bottom side of the outer conductor.

### Embodiment 12

Connector arrangement according to any one of Embodiments 1-11, wherein the deformation is formed as a corrugation (36).

### Embodiment 13

Connector arrangement according to any one of Embodiments 1-12, wherein the deformation is a planar deformation (38).

### Embodiment 14

Production method for a connector arrangement having the following steps:
providing a connector arrangement having a connector (12) and a cable (14) connected to the connector, which each have at least one conductor pair (16) for transmitting a differential signal, wherein the cable has a first portion (18) and the connector has a second portion (20) in which the conductor pair has electric contacts, wherein the cable is fastened to the connector at a connector-side end of the first portion and the conductors of the conductor pair of the cable are fastened to the conductors of the connector at a cable-side end of the second portion, wherein an intermediate portion (22) is formed between the first portion and the second portion, wherein the conductor pair is surrounded in the intermediate portion and, in particular, in the first portion and/or in the second portion by an outer conductor (24);
deforming the outer conductor in at least one part of the intermediate portion.

### LIST OF REFERENCE SIGNS

10 Connector arrangement
12 Connector
14 Cable
16 Conductor pair
18 First portion
20 Second portion
22 Intermediate portion
24 Outer conductor
26 Deformation
28 Longitudinal gap
30 Top side
32 Bottom side
34 Side face
36 Corrugation
38 Deformation
103 and 104 Opposite longitudinal edges/edges
V Distance between the outer conductor and the conductors
W Distance between the conductors in a region of the deformation

1. A connector assembly, comprising:
a cable comprising a first conductor and a second conductor;
a connector comprising a first electrical contact and a second electrical contact; and
a generally tubular outer conductor, wherein
said cable comprises a sheathed portion and an unsheathed end portion,
said outer conductor comprises a first portion radially outward of and generally coaxial to said sheathed portion and a second portion radially outward of and generally coaxial to said unsheathed end portion,
said unsheathed end portion is connected to said connector such that a first terminal portion of said first conductor electrically contacts said first electrical contact and a second terminal portion of said second conductor electrically contacts said second electrical contact,
said outer conductor comprises a first diameter that is smaller than a diameter of an imaginary convex curve tightly encircling an outer circumference of said first conductor and said second conductor in said unsheathed end portion.

2. The connector assembly of claim 1, wherein:
said first diameter that is smaller than a distance from said first terminal portion to said second terminal portion.

3. The connector assembly of claim 1, wherein:
said cable comprises an intermediate portion between said sheathed portion and said unsheathed end portion, and
said first diameter is a diameter of said outer conductor in a plane generally perpendicular to and intersecting said intermediate portion.

4. The connector assembly of claim 3, wherein:
a portion of said first conductor belonging to said sheathed portion, a portion of said first conductor belonging to said intermediate portion, a portion of said first conductor belonging to said unsheathed end portion, a portion of said second conductor belonging to said sheathed portion, a portion of said second conductor belonging to said intermediate portion, and a portion of said second conductor belonging to said unsheathed end portion are situated in a lumen of said outer conductor.

5. The connector assembly of claim 1, wherein:
said diameter of said imaginary convex curve is situated between said first diameter and said first terminal portion.

6. The connector assembly of claim 1, wherein:
said outer conductor comprises a third portion radially outward of said first terminal portion and said second terminal portion.

7. The connector assembly of claim 6, wherein:
said third portion is radially outward of said first electrical contact and said second electrical contact.

8. A connector assembly, comprising:
a cable comprising a first conductor and a second conductor;
a connector comprising a first electrical contact and a second electrical contact; and
a generally tubular outer conductor radially outward of and generally coaxial to said cable, wherein
said cable comprises a sheathed portion and an unsheathed end portion,
said outer conductor extends at least from said sheathed portion to said unsheathed end portion,
said unsheathed end portion comprises a first terminal portion of said first conductor and a second terminal portion of said second conductor,
said first terminal portion electrically contacts said first electrical contact and said second terminal portion electrically contacts said second electrical contact,
said outer conductor comprises a first diameter that is smaller than a distance from said first terminal portion to said second terminal portion.

9. The connector assembly of claim 8, wherein:
said cable comprises an intermediate portion between said sheathed portion and said unsheathed end portion, and
said first diameter is a diameter of said outer conductor in a plane generally perpendicular to and intersecting said intermediate portion.

10. The connector assembly of claim 8, wherein:
said outer conductor extends at least from said sheathed portion to said first terminal portion.

11. A connector assembly manufacturing method, comprising:
connecting a cable to a connector,
assembling a generally tubular outer conductor generally coaxial to said cable, and
shaping said outer conductor, wherein
said cable comprises a first conductor and a second conductor,
said connector comprises a first electrical contact and a second electrical contact,
said cable comprises a sheathed portion and an unsheathed end portion,
said assembling comprises situating said outer conductor such that a first portion of said outer conductor is radially outward of to said sheathed portion and a second portion of said outer conductor is radially outward of said unsheathed end portion,
said connecting comprises connecting said unsheathed end portion to said connector such that a first terminal portion of said first conductor electrically contacts said first electrical contact and a second terminal portion of said second conductor electrically contacts said second electrical contact,
said shaping comprises shaping said outer conductor such that a first diameter of said outer conductor is smaller than a diameter of an imaginary convex curve tightly encircling an outer circumference of said first conductor and said second conductor in said unsheathed end portion.

12. The connector assembly of claim 11, wherein:
said first diameter that is smaller than a distance from said first terminal portion to said second terminal portion.

13. The connector assembly of claim 11, wherein:
said cable comprises an intermediate portion between said sheathed portion and said unsheathed end portion, and
said first diameter is a diameter of said outer conductor in a plane generally perpendicular to and intersecting said intermediate portion.

14. The connector assembly of claim 13, wherein:
said assembling comprises assembling said outer conductor such that a portion of said first conductor belonging to said sheathed portion, a portion of said first conductor belonging to said intermediate portion, a portion of said first conductor belonging to said unsheathed end portion, a portion of said second conductor belonging to said sheathed portion, a portion of said second conductor belonging to said intermediate portion, and a portion of said second conductor belonging to said unsheathed end portion are situated in a lumen of said outer conductor.

15. The connector assembly of claim 11, wherein:
said diameter of said imaginary convex curve is situated between said first diameter and said first terminal portion.

16. The connector assembly of claim 11, wherein:
said assembling comprises situating said outer conductor such that a third portion of said outer conductor is radially outward of said first terminal portion and said second terminal portion.

17. The connector assembly of claim 6, wherein:
said assembling comprises situating said outer conductor such that said third portion is radially outward of said first electrical contact and said second electrical contact.

18. A connector assembly manufacturing method, comprising:
connecting a cable to a connector,
assembling a generally tubular outer conductor radially outward of and generally coaxial to said cable, and
shaping said outer conductor, wherein
said cable comprises a first conductor and a second conductor,
said connector comprises a first electrical contact and a second electrical contact,
said cable comprises a sheathed portion and an unsheathed end portion,
said assembling comprises situating said outer conductor such that said outer conductor extends at least from said sheathed portion to said unsheathed end portion,
said unsheathed end portion comprises a first terminal portion of said first conductor and a second terminal portion of said second conductor,
said connecting comprises connecting said cable to said connector such that said first terminal portion electrically contacts said first electrical contact and said second terminal portion electrically contacts said second electrical contact,
said shaping comprises shaping said outer conductor such that a first diameter of said outer conductor is smaller than a distance from said first terminal portion to said second terminal portion.

19. The connector assembly of claim 18, wherein:
said cable comprises an intermediate portion between said sheathed portion and said unsheathed end portion, and
said first diameter is a diameter of said outer conductor in a plane generally perpendicular to and intersecting said intermediate portion.

20. The connector assembly of claim 18, wherein:
said assembling comprises situating said outer conductor such that said outer conductor extends at least from said sheathed portion to said first terminal portion.
